(19) United States
(12) Patent Application Publication
(10) Pub. No.: US 2005/0034783 A1
(43) Pub. Date: Feb. 17, 2005

(54) Portable, dual-station, expandable carpenter's work bench

(76) Inventor: R. Wayne Laird, Spring, TX (US)

Correspondence Address: ANITA E. OSBORNE-LEE, 6810 PEBBLE BEACH DR., HOUSTON, TX, 77065, US

(21) Appl. No.: 10/638,190

(22) Filed: Aug. 11, 2003

(51) Int. Cl. B25H 1/00; B26D 1/14; B23D 19/00; B23D 33/02

(52) U.S. Cl. 144/286.5; 144/287; 83/471

(57) ABSTRACT

A portable, expandable carpenter's workbench which has the capability of accommodating two separate saws simultaneously. The height of the workpiece supports of the primary table saw work area can be adjusted from flush with the table saw support plate to various heights above the table saw support plate. The workpiece supports each have collapsible workpiece extension wings which allow a means of supporting longer workpieces and can optionally house means for measuring and bracing the workpiece for accuracy in cutting.

### CROSS-REFERENCE TO RELATED APPLICATIONS

Not applicable.

### STATEMENT REGARDING FEDERALLY SPONSORED RESEARCH and DEVELOPMENT

Not applicable.

### BACKGROUND OF THE INVENTION

1. Field of the Invention

This invention relates to carpenter's work benches and more particularly to an expandable, portable carpenter's work bench which allows the user to fully support and measure long boards while operating a power saw, such as a miter saw. Additionally, this invention can be configured to house two work areas where two people may use separate power saws at the same time.

2. Description of Prior Art

Carpenter's work benches or saw tables

Prior art includes U.S. Pat. No. 5,004,029 to Garner which gives an example of a carpenter's work bench with an adjustable recessed support for a portable saw so that the work piece has extended support when the operator is using the saw either at a set distance below the work piece or flush with the work piece. This prior art invention, however, only offers two options for the depth of the recess that holds the sawing apparatus. It does not allow the flexibility of varying the depth or vertical distance between the work piece and the sawing apparatus. It is conceivable that a carpenter would have to own various sizes of the prior art's table to compensate for different dimensioned saws.

Additionally, the above referenced prior art does not provide support for the portion of work piece beyond the edge of the surface holding the sawing apparatus. The extension wings of the prior are basically hollow and do not support work piece shorter than the full wing length. This same hollow characteristic of the support wings does not allow the operator to have a ready means to measure the work piece while operating the saw.

### BRIEF SUMMARY OF THE INVENTION

The present invention is a new, improved portable, collapsible workbench which allows the use of two separate types of saws simultaneously and provides support, measurement capability and workpiece bracing functions utilizing retractable extension arms.

Objects and Advantages

Accordingly, several objects and advantages of this invention are:
1) it provides a compact work area for accurately and safely operating two power saws, such as a miter and router saw, separately or simultaneously;
2) it allows the operator to safely and easily support long workpieces;
3) this invention provides a means to accurately measure the workpiece while providing a stable support area; and
4) it provides the operator with a fully functional yet portable work bench that may be moved to the necessary work area or stored away when not in use.

Further objects and advantages of this invention will become apparent from a consideration of the drawings and ensuing description.

### BRIEF DESCRIPTION OF DRAWINGS

FIG. 1 is a top perspective view of the expandable, portable carpenter's workbench configured for use with both a miter and router saw with the incoming and outgoing extension guide arms in the upright and locked position.

FIG. 2 is a bottom perspective view of the expandable, portable carpenter's workbench configured for use with both a miter and router saw with the incoming and outgoing extension guide arms in the upright and locked position.

FIG. 3 is a top perspective view of the expandable, portable carpenter's workbench configured for use with a single miter saw with the secondary saw support table, the incoming and outgoing extension guide arms in the in the downward, stowed position.

FIG. 4 is a close-up view of the telescoping support leg of the extension guide arm.

FIG. 5 is a bottom perspective view of the rear, secondary saw support table in the upright and locked position.

FIG. 6 is an exploded view of the junction between the primary saw support and workpiece support arm.

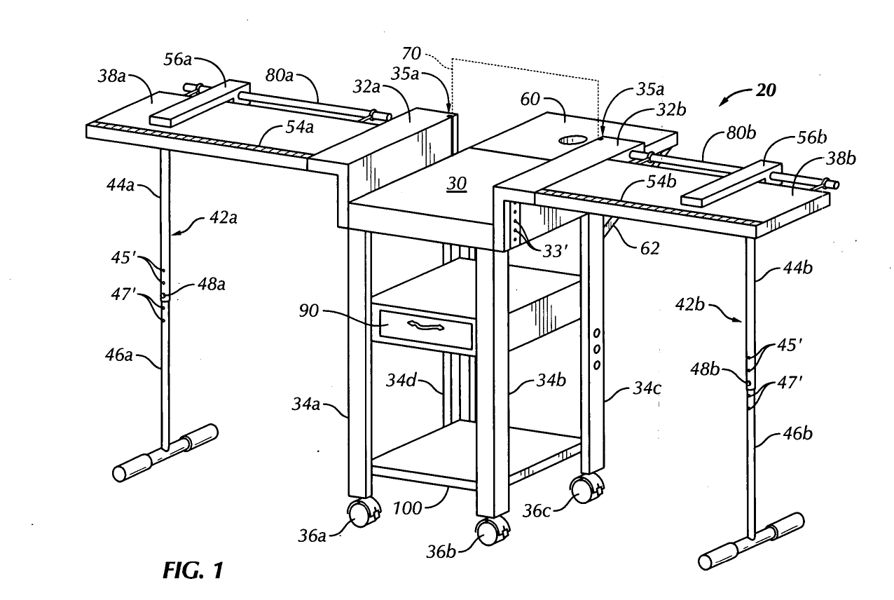

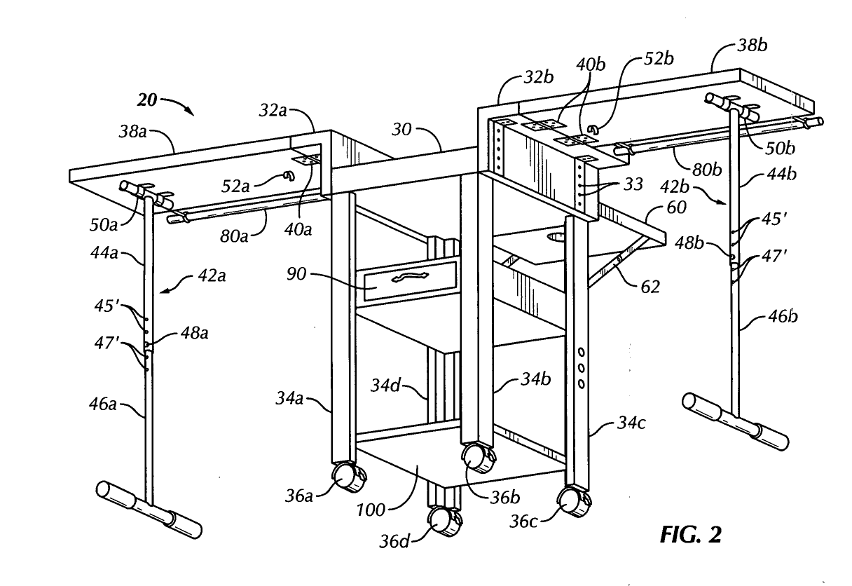

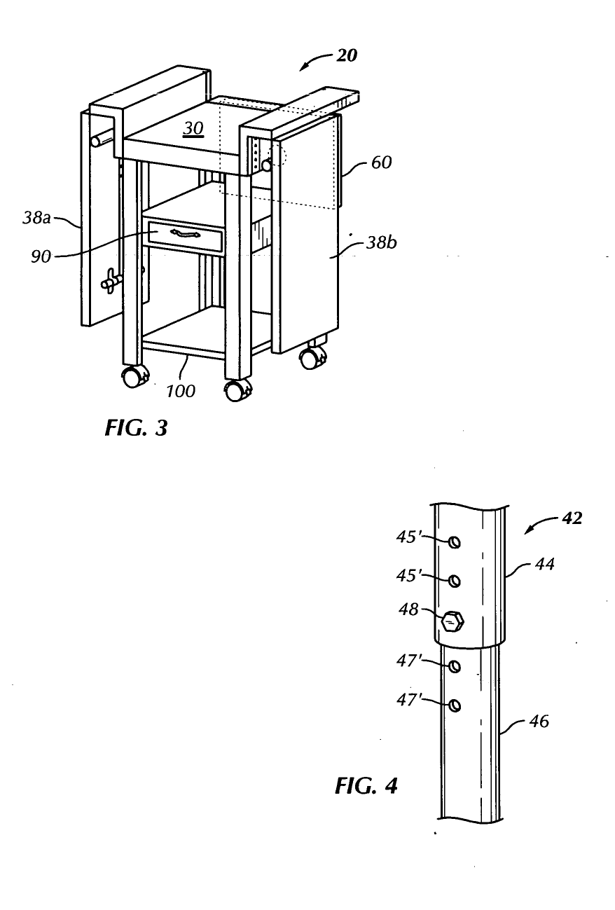

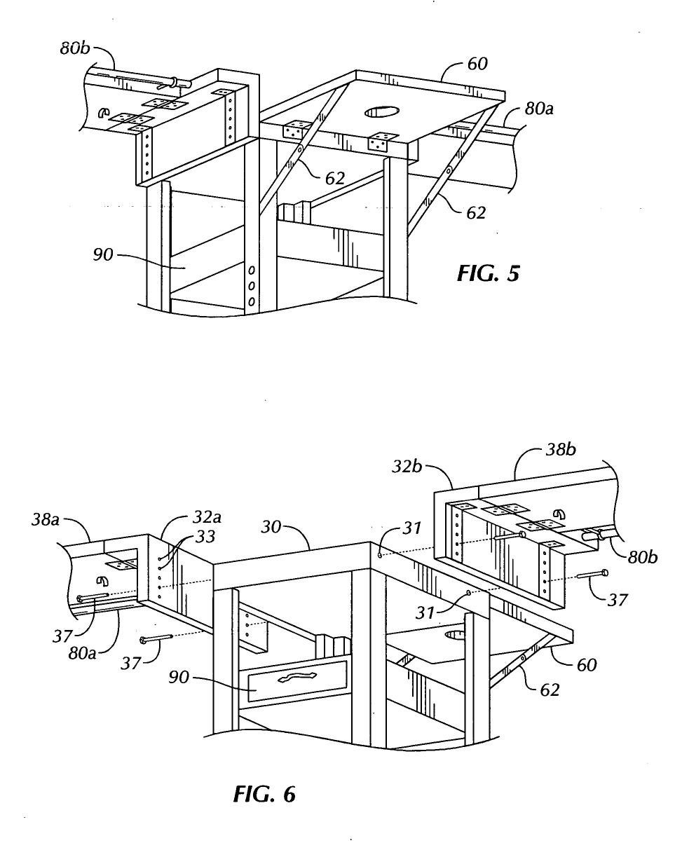

### REFERENCE NUMERALS IN DRAWINGS

| | |
|---|---|
| 20 | dual-station expandable, portable carpenter's work |
| | bench |
| 30 | primary horizontal rigid table plate member (primary |
| | saw support) |
| 31′ | workpiece support receiving mounting holes |
| 32a/32b | first and second workpiece support |
| 33′ | workpiece support mounting holes |
| 35a/35b | workspace divider vertical channel |
| 34a/34b/34c/34d | first, second, third and fourth elongated leg member, |
| | respectively |
| 36a/36b/36c/36d | first, second, third and fourth locking wheel, |
| | respectively. |
| 37′ | workpiece support fastener |
| 38a/38b | first and second extension arm |
| 40a/40b | first and second [elongate] hinge |
| 42a/42b | first and second telescoping support leg |
| 44a/44b | top portion of telescoping support leg 42a and 42b, |
| | respectively |
| 45′ | equidistant holes in top portion of telescoping support |
| | leg 44a and 44b, respectively |
| 46a/46b | bottom portion of telescoping support leg 42a and 42b, |
| | respectively |
| 47′ | equidistant holes in bottom portion of telescoping |
| | support leg 46a and 46b, respectively |
| 48a/48b | telescoping support leg fasteners |
| 50a/50b | leg member junction |
| 52a/52b | u-clamp (or comparable means) to secure the |
| | telescoping support leg to the extension arm |
| 54a/54b | measuring strip for first and second workpiece |
| | extension arm |
| 56a/56b | workpiece stop |
| 60 | secondary horizontal rigid table plate member |
| | (secondary saw support) |
| 62 | locking hinge |
| 70 | optional workspace divider |

### DETAILED DESCRIPTION OF THE INVENTION

The carpenter's workbench 20 of the instant invention essentially compromises a primary horizontal rigid table plate member 30, with spaced parallel ends, with a first and second workpiece support 32a and 32b mounted to the opposite ends of the primary horizontal rigid table plate member. The first and second workpiece support 32a and 32b are inverted L-shaped members with the horizontal portion oriented on top and the vertical member containing equidistant workpiece support mounting holes 33′ aligned with the workpiece support receiving mounting holes 31′ on the left and right side of primary horizontal rigid table plate member 30, respectively. Each first and second workpiece support 32a and 32b is connected to the primary horizontal rigid table plate member 30 by using workpiece support fasteners 37′ which pass though the workpiece support mounting holes 33′ and the workpiece support receiving mounting holes 31′. The first and second workpiece support 32a and 32b each have a vertical channel 35a and 35b, respectively, along the inside rear surface to house an optional workspace divider 70.

A first, second, third and fourth elongated leg member 34a, 34b, 34c, and 34d respectively are directed downward from a bottom surface of the primary horizontal rigid table plate member 30. The lower terminal ends of each leg member 34a, 34b, 34c, and 34d include a locking wheel 36a, 36b, 36c, and 36d respectively.

The first and second workpiece support 32a and 32b respectively connect a first and second extension arm 38a and 38b by a first and second hinge 40a and 40b. Each extension arm 38a and 38b is connected to a first and second telescoping support leg 42a and 42b. Each support leg 42a and 42b is composed of a bottom portion 46a and 46b with equidistant holes 47′ which fits into the respective top portion 44a and 44b with equidistant holes 45′. Each bottom portion 46a and 46b is secured within each top portion 42a and 42b respectively by fasteners 48a and 48b through holes 45′ and 47′. The holes 45′ and 47′ are spaced to be consistent with the spacing of mounting holes 31′ and 33′ to ensure that the support legs 42a and 42b are the appropriate height for the workpiece support setting. Each top portion 44a and 44b of said support legs 42a and 42b is mounted to the bottom side of the terminal end of each extension arm respectively with a leg member junction 50a and 50b. The first and second support leg 42a and 42b is secured to the bottom surface of the first and second extension arm 38a and 38b by a u-clamp 52a and 52b, respectively, when not in use to support either extension arm 38a or 38b.

The secondary horizontal rigid table plate member 60 is attached to the back end of the primary horizontal rigid table plate member 30 with a locking hinge 62.

The preferred embodiment of the saw table apparatus allows the user of the primary miter saw to both measure and brace the workpiece. This is accomplished by the having first and second workpiece extension arm 38a and 38b each contain a measuring strip 54a and 54b affixed to the top surface area, a perpendicularly-aligned workpiece stop 56a and 56b connected to a guide rod 58a and 58b mounted parallel to the back edge of each extension arm 38a and 38b respectively.

1. A saw table, work station apparatus, comprising in combination:
a) a primary horizontal, table plate member; and
b) a first, second, third and fourth elongated leg member attached downward from a bottom surface of said primary horizontal rigid table plate member with the lower terminal ends of each leg member connected to an optional a locking wheel; and
c) a first and second inverted L-shaped first workpiece support with a means to be attached to the opposite ends of the primary horizontal rigid table plate member at varying heights; and
d) a first and second extension arm hingedly connected to the first and second workpiece support, respectively; and
e) a first and second telescoping support leg connected to the bottom side of each first and second extension arm, respectively, whereby each said support legs is composed of a bottom portion which fits into the top portion of said support leg top portion with a means of securing the support leg height; and
f) a means to secure the first and second support leg flush to the bottom surface of the first and second extension arm, respectively; and
g) a secondary horizontal rigid table plate member attached to the back end of the primary horizontal rigid table plate member with a locking hinge or other suitable mechanism.

2. The saw table apparatus in claim 1, wherein the primary horizontal, table plate member contains a channel along the back end; and the first and second workpiece support each have a vertical channel along the inside rear surface to house an optional workspace divider.

3. The saw table apparatus in claim 1 whereby the first and second workpiece extension arms each contain a means for measuring length, such as a measuring strip, affixed to the top surface area.

4. The saw table apparatus in claim 1 whereby the first and second workpiece extension arms each contain a perpendicularly-aligned workpiece stop connected to a guide rod mounted parallel to the back edge of each extension arm, respectively.

5. The saw table apparatus in claim 2 whereby the first and second workpiece extension arms each contain a means for measuring length, such as a measuring strip, affixed to the top surface area.

6. The saw table apparatus in claim 5 whereby the first and second workpiece extension arms each contain a perpendicularly-aligned workpiece stop connected to a guide rod mounted parallel to the back edge of each extension arm, respectively.

7. The saw table apparatus in claim 1 wherein the apparatus contains one or more horizontal plate members, storage units, such as a drawer, or a combination of horizontal plate members or storage units affixed below the primary horizontal plate member.

8. The saw table apparatus in claim 1 wherein the apparatus contains one or more horizontal plate members, storage units, such as a drawer, or a combination of horizontal plate members or storage units affixed below the primary horizontal plate member.
